(19) United States
(12) Patent Application Publication
(10) Pub. No.: US 2026/0114426 A1
(43) Pub. Date: Apr. 30, 2026

(54) RETRACTABLE LEASH WITH ADJUSTABLE MAXIMUM LENGTH MECHANISM

(71) Applicant: Black Marble Holdings, LLC, Smyrna, GA (US)

(72) Inventor: Michael Casey, Smyrna, GA (US)

(21) Appl. No.: 19/366,892

(22) Filed: Oct. 23, 2025

Related U.S. Application Data
(60) Provisional application No. 63/712,720, filed on Oct. 28, 2024.

(51) Int. Cl. A01K 27/00

(52) U.S. Cl. CPC A01K 27/004

(57) ABSTRACT

A retractable leash apparatus may comprise a housing and a reel rotatably mounted within the housing. A leash may be wound around the reel and extendable from the housing. A threaded drive shaft may be coupled to the reel and configured to rotate with the reel. A threaded connector nut may be engaged with the drive shaft and constrained from rotation within the housing. A threaded limiter may be engaged with the connector nut and positioned to contact the drive shaft. A manual control may be accessible from an exterior of the housing and coupled to the limiter to allow user adjustment of a position of the limiter. Rotation of the reel may cause the drive shaft to rotate and advance the connector nut along the drive shaft until the drive shaft contacts the limiter to limit extension of the leash.

### RELATED APPLICATION

Under provisions of 35 U.S. C. § 119(e), the Applicant claims benefit of U.S. Provisional Application No. 63/712,720 filed on Oct. 28, 2024, and having inventors in common, which is incorporated herein by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to pet accessories and animal control devices. More specifically, it pertains to improvements in retractable leash mechanisms used for controlling and restraining animals, particularly dogs.

### BACKGROUND

Retractable leashes are popular among pet owners, and particularly among owners due to their ability to provide variable leash lengths. Such leashes may allow dogs more freedom to explore while still maintaining control. Conventional retractable leashes may typically consist of a housing containing a spring-loaded reel mechanism that extends and retracts a thin cord or tape leash.

However, these conventional designs may have several limitations. When locked, they may prevent both extension and retraction of the leash, potentially leading to slack when the dog moves closer to the user. This slack may cause tangling, tripping hazards, and reduced control over the dog. Additionally, conventional systems only offer binary control either fully locked or completely unlocked-without the ability to set intermediate maximum extension lengths. Users may not be able to easily set a specific maximum length while maintaining retraction capability.

Furthermore, existing retractable leashes require constant manual intervention to maintain proper length control. Users must repeatedly lock and unlock the mechanism as conditions change, which is inconvenient and may compromise safety during critical moments. The inability to preset a maximum extension length means that users cannot proactively prevent their pets from extending the leash beyond safe or appropriate distances for specific environments or situations.

These limitations manifest as various technical problems in real-world applications. In crowded urban environments, pet owners cannot effectively limit leash extension to prevent their animals from approaching strangers, entering roadways, or interfering with pedestrian traffic while maintaining the ability to retract the leash as needed. During training sessions, the lack of adjustable maximum length prevents consistent enforcement of boundary limits, as the binary lock/unlock system disrupts the natural tension feedback essential for effective animal control. In multi-pet households, the inability to set different maximum lengths for different animals creates management difficulties and potential safety hazards. Additionally, when transitioning between different environments such as from open parks to busy sidewalks, users cannot quickly adjust maximum extension limits without stopping to manually reconfigure the entire leash system.

Some attempts may have been made to improve retractable leash designs, such as adding multiple locking positions or incorporating brake systems. However, these solutions may often compromise the simplicity and ease of use that make retractable leashes popular.

These limitations in conventional retractable leash designs create safety concerns and reduce the overall effectiveness of the leash as a control mechanism, particularly in situations where precise length control is essential for pet and public safety. Some attempts may have been made to improve retractable leash designs, such as adding multiple locking positions or incorporating brake systems. However, these solutions may often compromise the simplicity and ease of use that make retractable leashes popular.

The current state of the art in retractable leashes may not adequately address these issues. There may be a need for improved retractable leash designs that can overcome the limitations of conventional systems while maintaining their benefits.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A retractable leash apparatus may comprise a housing with a reel rotatably mounted within the housing. A leash may be wound around the reel and extendable from the housing. A threaded drive shaft may be coupled to the reel and configured to rotate with the reel. A threaded connector nut may be engaged with the drive shaft and constrained from rotation within the housing. A limiter may be engaged with the connector nut and positioned to contact the drive shaft. A manual control may be accessible from an exterior of the housing and coupled to the limiter to allow user adjustment of a position of the limiter. Rotation of the reel may cause the drive shaft to rotate and advance the connector nut along the drive shaft until the drive shaft contacts the limiter to limit extension of the leash.

A retractable leash apparatus may comprise a housing with a reel rotatably mounted within the housing. A leash may be wound around the reel and extendable from the housing. A threaded drive shaft may be coupled to the reel and configured to rotate with the reel. A threaded connector nut may be engaged with the drive shaft and constrained from rotation within the housing. A limiter may be engaged with the connector nut and positioned to contact the drive shaft. A manual control may be accessible from an exterior of the housing and coupled to the limiter to allow user adjustment of a position of the limiter. Rotation of the reel may cause the drive shaft to rotate and advance the connector nut along the drive shaft until the drive shaft contacts the limiter to limit extension of the leash.

A retractable leash apparatus may comprise a housing with a reel rotatably mounted within the housing. A leash may be wound around the reel and extendable from the housing. A threaded drive shaft may be coupled to the reel and configured to rotate with the reel. A threaded connector nut may be engaged with the drive shaft and constrained from rotation within the housing. A limiter may be engaged with the connector nut and positioned to contact the drive shaft. A manual control may be accessible from an exterior of the housing and coupled to the limiter to allow user adjustment of a position of the limiter. A brake mechanism may be configured to selectively prevent rotation of the reel to lock the leash at any desired length. Rotation of the reel may cause the drive shaft to rotate and advance the connector nut along the drive shaft until the drive shaft contacts the limiter to limit extension of the leash.

A retractable leash apparatus may comprise a housing. A reel may be rotatably mounted within the housing. A leash may be wound around the reel and extendable from the housing. A threaded drive shaft may be coupled to the reel and configured to rotate with the reel. A threaded connector nut may be engaged with the drive shaft and constrained from rotation within the housing. A limiter may be engaged with the connector nut and positioned to contact the drive shaft. A manual control may be accessible from an exterior of the housing and coupled to the adjustment screw to allow user adjustment of a position of the adjustment screw. A gearing mechanism may comprise a drive gear coupled to the drive shaft. The gearing mechanism may comprise an adjustment gear coupled to the adjustment screw. The gearing mechanism may comprise at least one intermediate gear meshed between the drive gear and the adjustment gear. The at least one intermediate gear may be configured to selectively engage the adjustment gear. The gearing mechanism may be configured to maintain a fixed relative position between the drive shaft and the adjustment screw when the at least one intermediate gear is engaged. Rotation of the reel may cause the drive shaft to rotate and advance the connector nut along the drive shaft until the drive shaft contacts the adjustment screw to limit extension of the leash.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a perspective view of a retractable leash with adjustable maximum length mechanism;

FIG. 2 illustrates a partial cutaway view of the retractable leash with adjustable maximum length mechanism, with the leash in the retracted position and the maximum length set to coincide with the length of the leash line;

FIG. 3 illustrates a partial cutaway view of the retractable leash with adjustable maximum length mechanism, with the leash line fully extended;

FIG. 4 illustrates a partial cutaway view of the retractable leash with adjustable maximum length mechanism, with the leash in the retracted position and the maximum length set to be limited to less than the length of the leash line;

FIG. 5 illustrates a partial cutaway view of the retractable leash with adjustable maximum length mechanism, with the leash line extended to the maximum allowable length, less than the full length of the leash line;

FIG. 6 illustrates a partial view of the leash mechanism for use in a retractable leash with adjustable maximum length; and

FIG. 7 is a flowchart illustrating one method for use of the retractable leash with adjustable maximum length mechanism.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S. C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The technical problem addressed by this apparatus centers on the limitations of conventional retractable leashes, which may create safety hazards and control difficulties during pet management activities. Traditional retractable leashes may allow uncontrolled extension to the full length of the leash line, potentially creating dangerous situations where pets may venture too far from their owners. The primary use case involves dog walking scenarios where owners desire to provide their pets with freedom of movement while maintaining appropriate boundaries for safety and control.

Conventional retractable leashes may present several operational challenges across different usage scenarios. In urban environments, dogs may extend their leashes into roadways or crowded pedestrian areas, creating hazards for both the animal and surrounding individuals. The lack of adjustable maximum length control may force owners to rely solely on manual brake mechanisms, which may require constant attention and immediate reaction times that may not always be feasible during extended walking sessions.

In training scenarios, conventional retractable leashes may hinder the development of proper leash behavior in dogs. Young or untrained animals may learn to pull against the constant tension without understanding appropriate boundaries. The inability to set consistent maximum distances may interfere with establishing reliable recall distances and may complicate the training process for both novice and experienced pet owners.

Park and recreational environments may present additional challenges where conventional retractable leashes may allow pets to interfere with other animals, people, or activities beyond the owner's intended range. The fixed maximum extension of traditional designs may be either too restrictive for open areas or too permissive for crowded conditions, requiring owners to manually control extension throughout the activity.

Multiple pet scenarios may compound these difficulties, as conventional retractable leashes may not provide the individual length control needed when walking dogs of different sizes or energy levels simultaneously. Larger dogs may extend to the full leash length while smaller companions may require shorter maximum distances for safety, creating management challenges that conventional designs may not adequately address.

The apparatus disclosed herein may address these technical problems through the implementation of a threaded drive shaft that may be coupled to reel. The drive shaft may rotate in correspondence with reel rotation during leash extension and retraction operations. A threaded connector nut may be engaged with the drive shaft and may be constrained from rotation within housing through a complementary channel configuration that may prevent rotational movement while allowing linear translation along the drive shaft axis.

A limiter may be engaged with connector nut and may be positioned to contact drive shaft when the connector nut advances to a predetermined position during leash extension. The contact between drive shaft and limiter may create a mechanical stop that may limit further extension of leash while maintaining the retraction capability provided by spring mechanism.

The position of the limiter may be manually adjustable through a control mechanism accessible from the exterior of housing, allowing users to set variable maximum extension lengths according to specific environmental conditions or training requirements. This configuration may eliminate the uncontrolled extension problem inherent in conventional designs while preserving the automatic retraction functionality that makes retractable leashes advantageous for pet management applications.

The present disclosure includes many aspects and features. Moreover, while many aspects and features relate to, and are described in, the context of a retractable leash, embodiments of the present disclosure are not limited to use only in this context.

Features, functions, and elements described in connection with one embodiment may be implemented with or substituted into other embodiments unless otherwise specified. Equivalent mechanisms, controls, or transmission systems may be substituted for any described element without departing from the scope of the disclosure.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The retractable leash apparatus may comprise a housing with a reel rotatably mounted within. A leash may be wound around the reel and extendable from the housing. The apparatus may include a drive screw coupled to the reel and configured to rotate with the reel. A connector piece may be threadedly engaged with the drive screw and constrained from rotation within the housing. A limiter (e.g., a pin, screw, plate, etc.) may be engaged with and/or disposed at least partially within the connector piece.

In some embodiments, rotation of the reel may cause the drive screw to rotate and move the connector piece along an axis of the drive screw until the drive screw contacts the limiter to limit extension of the leash. The connector piece may comprise a hexagonal nut and the housing may comprise a hexagonal channel configured to receive the hexagonal nut and prevent rotation of the hexagonal nut.

The apparatus may further include a spring mechanism coupled to the reel and configured to bias the reel toward a retracted position. A ball bearing may be disposed between an end of the drive screw and an end of the limiter. In some implementations, the drive screw and the limiter may have oblique ends configured to minimize contact surface area between the screws.

Some embodiments may include a dial coupled to the limiter and accessible from an exterior of the housing to allow manual adjustment of a position of the limiter. The apparatus may also comprise a gearing system configured to maintain a fixed relative position between the drive screw and the limiter when engaged. The gearing system may include a drive gear coupled to the drive screw, an adjustment gear coupled to the limiter, and at least one intermediate gear meshed between the drive gear and the adjustment gear.

A rocker arm may be pivotally mounted within the housing and coupled to at least one gear of the gearing system. The rocker arm may be configured to selectively engage and disengage the gearing system. A switch accessible from an exterior of the housing may be operatively connected to the rocker arm to allow a user to selectively engage and disengage the gearing system.

In some embodiments, the apparatus may include a locking mechanism configured to selectively lock the limiter in a fixed position relative to the housing. When the limiter is locked, rotation of the reel may cause the drive screw to rotate and move the connector piece along an axis of the drive screw until the drive screw contacts the limiter to limit extension of the leash while still allowing retraction of the leash.

The locking mechanism may comprise a gear coupled to the limiter and a movable arm configured to selectively engage the gear to prevent rotation of the limiter. A spring mechanism coupled to the reel may be configured to bias the reel toward a retracted position, wherein the spring mechanism maintains tension on the leash when extended to the limit set by the locked limiter.

Embodiments of the present disclosure may comprise systems and components including (but not limited to) at least one of the following:
A. A housing component;
B. A reel component;
C. A spring component;
D. A leash line component;
E. A drive screw component;
F. A limiter component;
G. A connector component;

In some embodiments, the present disclosure may provide an additional set of modules for further facilitating the software and hardware platform. The additional set of modules may comprise, but not be limited to:
H. a Ball Bearing;
I. A gearing mechanism; and
J. A traditional locking mechanism component.

Details with regards to each component are provided below. Although components are disclosed with specific functionality, it should be understood that functionality may be shared between components, with some functions split between components, while other functions are duplicated by the components.

The following depicts an example of a method of a plurality of methods that may be performed by at least one of the aforementioned components. Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
Receive an input to extend the leash line;
Rotate the reel and drive screw to extend the leash line;
Monitor the position of the drive screw relative to the limiter;
When the drive screw contacts the limiter, prevent further extension;
Allow retraction of the leash line at any point by reversing rotation of the drive screw;
Receive an input to adjust the maximum length; and
Adjust the position of the limiter based on the input.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

A retractable leash apparatus 100 may comprise a housing assembly with a reel mechanism rotatably mounted within the housing. A leash line may be wound around the reel and may be extendable from the housing through a leash exit opening. The apparatus may provide enhanced control over leash extension distances while maintaining automatic retraction capability through a spring mechanism that may bias the reel toward a retracted position.

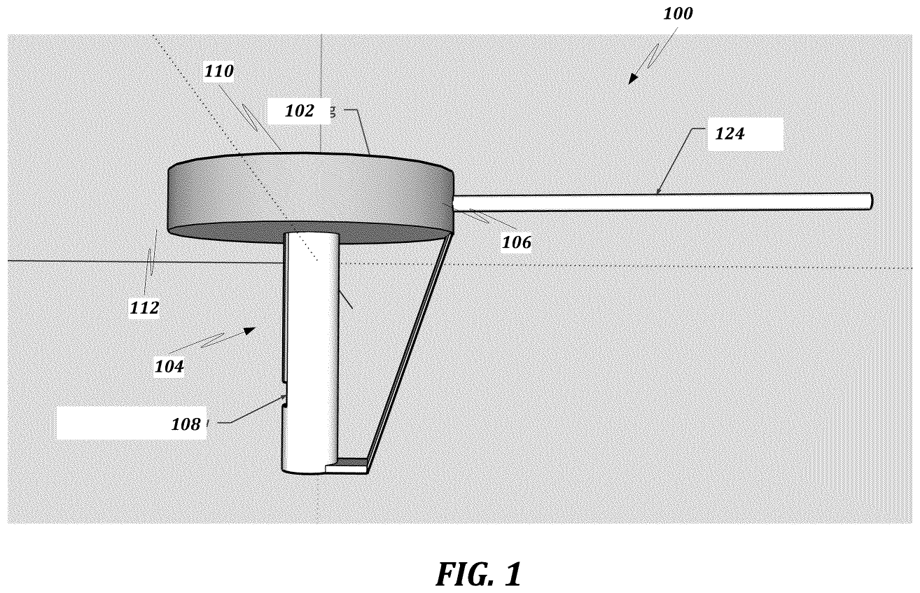

As illustrated in FIG. 1, the apparatus 100 may comprise a housing that may contain and protect the internal components of the retractable leash system. The housing may be constructed from durable materials such as reinforced polycarbonate, aluminum alloy, or engineering plastics that may provide impact resistance and weather protection for the internal mechanisms. The housing may include an adjustment window that may provide visual access to adjustment controls and position indicators for user feedback regarding the current maximum extension setting.

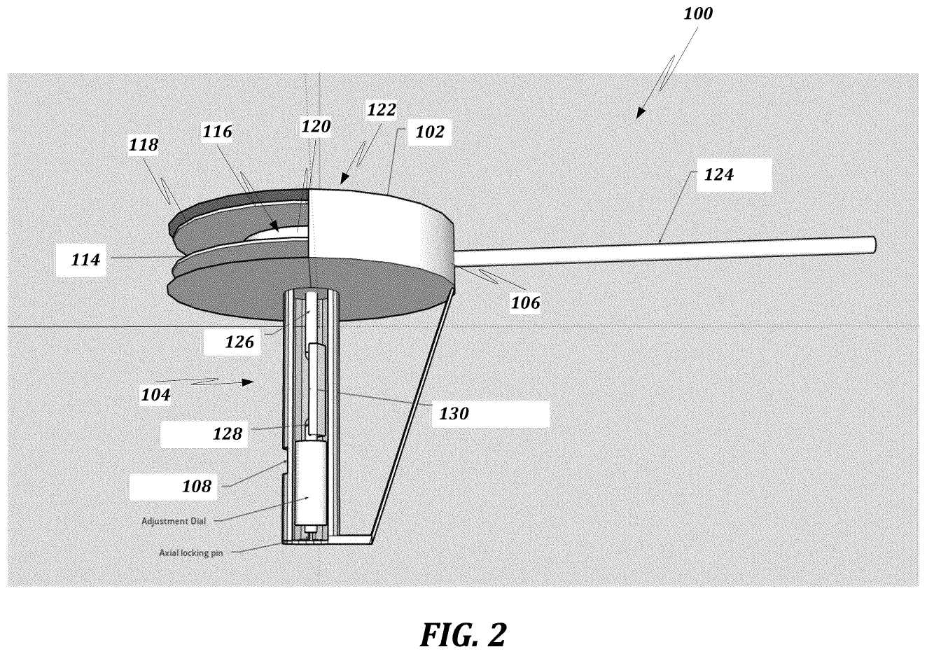

The apparatus 100 may include a threaded drive shaft that may be mechanically coupled to the reel such that rotation of the reel during leash extension operations may cause corresponding rotation of the drive shaft. As shown in FIG. 2, the drive shaft may be positioned parallel to the axis of reel rotation and may extend through a central portion of the housing assembly. The threaded exterior surface of the drive shaft may be configured to engage with a complementary threaded connector component that may translate linearly along the drive shaft axis during operation.

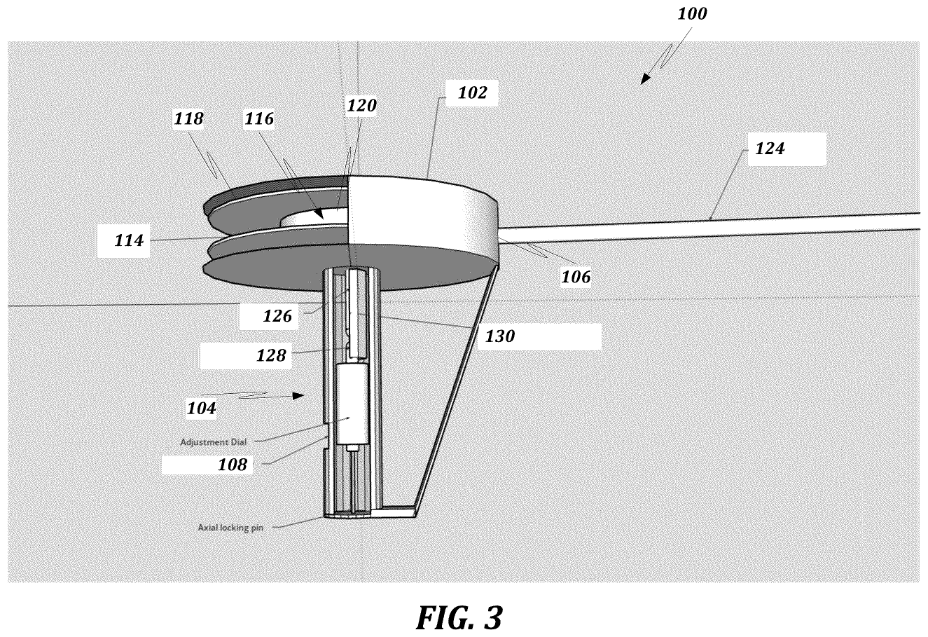

A threaded connector nut may be engaged with the drive shaft and may be constrained from rotation within the housing through a non-circular channel configuration. As depicted in FIG. 3, the connector nut may comprise a hexagonal cross-section that may correspond to a shaped channel formed within the housing. This configuration may allow the connector nut to translate linearly along the axis of the drive shaft while preventing rotational movement of the connector nut relative to the housing. The hexagonal channel may be machined or molded with precise dimensional tolerances to ensure proper fit with the connector nut while minimizing play that may cause operational noise or wear.

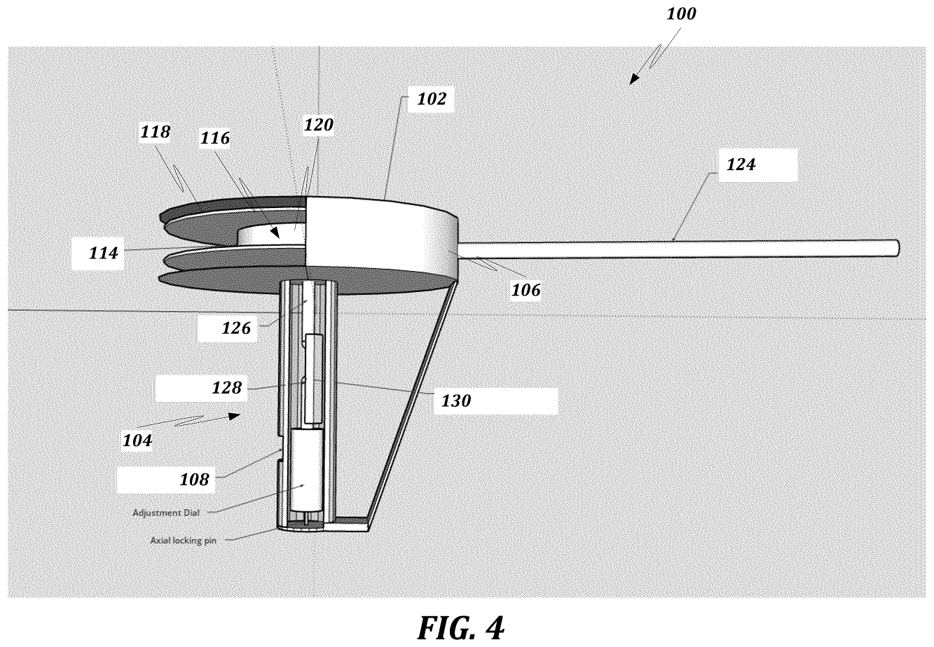

FIG. 4 illustrates how a limiter may be positioned to interact with the connector nut and may extend through the connector nut along an axis parallel to the drive shaft. The limiter may have external threads that may engage with internal threads formed in the connector nut. The position of the limiter relative to the connector nut may be manually adjustable through a control mechanism accessible from the exterior of the housing. The limiter may be configured to contact the drive shaft when the connector nut advances to a predetermined position during leash extension.

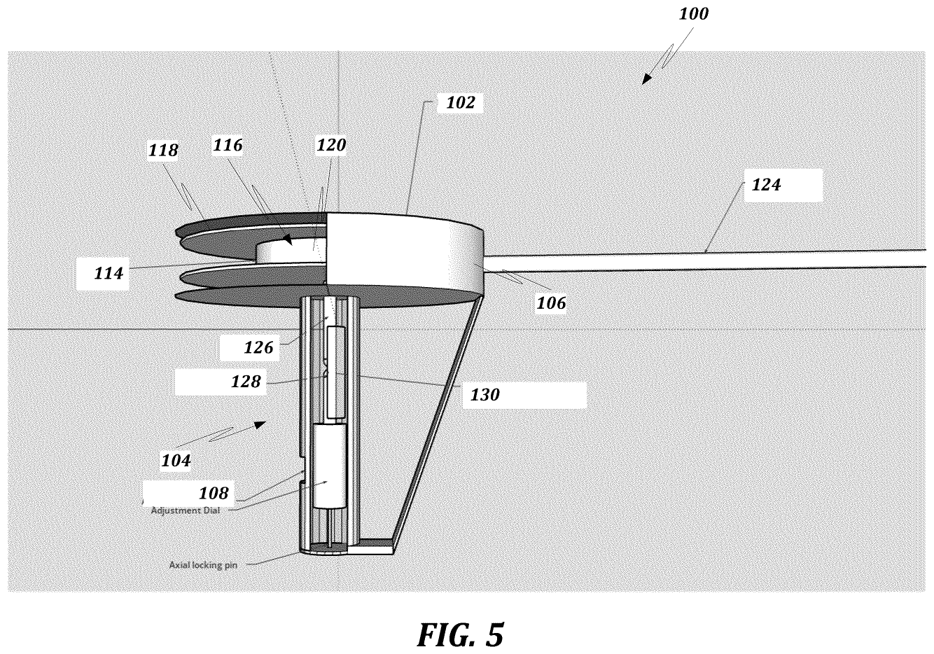

During operation, extension of the leash line may cause the reel to rotate, which may in turn cause the drive shaft to rotate. The rotation of the drive shaft may advance the connector nut along the threaded shaft until the drive shaft contacts the limiter. As shown in FIG. 5, this contact may create a mechanical stop that may prevent further extension of the leash line while maintaining the ability for the spring mechanism to retract the leash line when extension force is reduced.

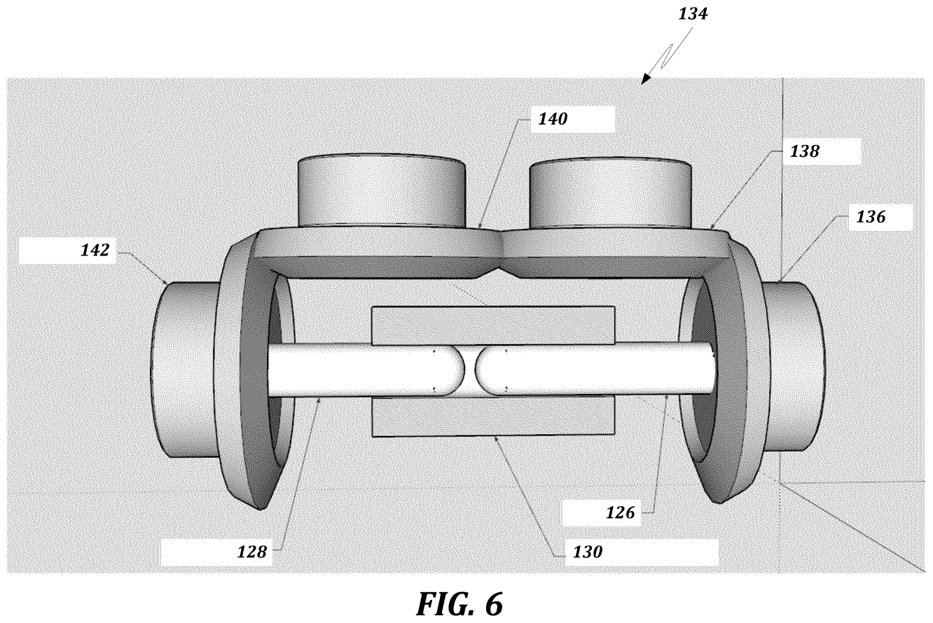

The apparatus 100 may include a gearing system that may provide enhanced operational flexibility by allowing selective engagement and disengagement of the maximum length adjustment mechanism. As illustrated in FIG. 6, the gearing system may comprise a drive gear that may be mechanically coupled to the drive shaft such that rotation of the drive shaft may cause corresponding rotation of the drive gear. An adjustment gear may be coupled to the limiter such that rotation of the adjustment gear may cause rotational movement of the limiter within the connector nut.

The gearing system may include intermediate gears positioned between the drive gear and adjustment gear to provide the mechanical connection that may maintain a fixed relative position between the drive shaft and limiter when the gearing system is engaged. The intermediate gears may comprise a primary gear and a reverse gear that may be configured to provide the appropriate rotational relationship between the drive gear and adjustment gear. The gear ratios may be selected to ensure that rotation of the drive shaft may cause an equal and opposite rotation of the limiter, thereby maintaining a constant relative position between these components during leash extension operations.

The apparatus 100 may include a friction-reducing element that may be positioned between the drive shaft and limiter to minimize wear during contact operations. The friction-reducing element may comprise a ball bearing, roller bearing, or other suitable low-friction component that may rotate freely to reduce sliding friction when the drive shaft contacts the limiter during maximum extension operations. The drive shaft and limiter may comprise tapered or oblique contact surfaces that may be configured to provide smooth engagement and minimize binding during contact.

The apparatus 100 may include a traditional brake mechanism that may be configured to selectively prevent rotation of the reel in both directions to lock the leash at any desired length. The traditional brake mechanism may comprise a pawl element that may engage with teeth formed on the periphery of the reel. The pawl may be spring-loaded to maintain engagement with the reel teeth when activated. An actuator accessible from the exterior of the housing may be operatively connected to the pawl to selectively engage and disengage the pawl with the reel teeth.

The spring mechanism may be configured to maintain retraction force on the leash when the brake mechanism is engaged. The spring mechanism may continue to bias the reel toward the retracted position even when the brake prevents reel rotation, ensuring that retraction force may be immediately available when the brake is released. The spring mechanism may comprise a spiral torsion spring having one end fixed to the housing and another end attached to the reel hub.

The limiter may be positioned to provide variable maximum extension lengths depending upon user requirements. A manual control dial may be coupled to the limiter and may be accessible from the exterior surface of the housing to allow users to adjust the position of the limiter. Rotation of the control dial may cause corresponding rotation of the limiter, which may advance or retract the limiter within the connector nut to establish different maximum extension limits.

The housing may comprise multiple sections that may be joined together to allow access to internal components for maintenance or repair. The housing sections may be connected through threaded joints, snap-fit connections, or other suitable fastening methods. Sealing elements may be positioned between housing sections to provide weather resistance and prevent moisture ingress into the internal mechanism.

Accordingly, embodiments of the present disclosure provide a software and hardware platform comprised of a distributed set of computing elements, including, but not limited to:

### A. a Housing Component

The leash apparatus 100 may include a housing 102. The housing 102 may be configured to contain and protect the internal components of the retractable leash apparatus while providing structural support for the operational mechanisms. The housing 102 may comprise a multi-piece construction that may allow for assembly and maintenance access to the internal components. The housing sections may be joined through threaded connections, snap-fit assemblies, or bayonet-type fastening mechanisms that may provide secure attachment while allowing disassembly when required.

The housing 102 may be constructed from impact-resistant materials such as reinforced polycarbonate, aluminum alloy, or engineering-grade thermoplastics that may provide durability under normal operational conditions. The material selection may balance weight considerations with structural integrity requirements to ensure comfortable handling while maintaining protection for the internal mechanisms. The housing 102 may include reinforcement ribs or structural elements in high-stress areas to distribute operational loads throughout the assembly.

The housing 102 may include an ergonomic grip portion 104 that may be configured to provide comfortable handling during extended use periods. The grip portion 104 may comprise textured surfaces or elastomeric materials that may enhance grip security and reduce hand fatigue. The grip configuration may be sized to accommodate various hand sizes while maintaining secure control during leash operations.

The housing 102 may define a leash exit opening 106 through which the leash line may extend and retract during operation. The leash exit opening 106 may include guide elements or bushings that may direct the leash line path while minimizing friction and wear. The opening dimensions may be sized to accommodate the leash line diameter while preventing binding during extension and retraction cycles.

The housing 102 may incorporate an adjustment window 108 that may provide visual access to internal adjustment mechanisms and position indicators. The adjustment window 108 may comprise a transparent or translucent material that may allow observation of the adjustment mechanism position while maintaining protection from environmental elements. The window may include graduated markings or position indicators that may provide feedback regarding the current maximum extension setting.

The housing 102 may define internal cavities and mounting surfaces that may accommodate the reel assembly, drive mechanisms, and adjustment components. The internal configuration may provide precise positioning and support for rotating elements while maintaining proper alignment throughout the operational range. The housing 102 may include bearing mounting surfaces that may support the reel assembly and drive shaft components with appropriate tolerances for smooth operation.

The housing 102 may include ventilation features 110 that may prevent moisture accumulation within the internal cavity while maintaining weather protection for the mechanism components. The ventilation features 110 may comprise strategically positioned ports or channels that may allow air circulation without compromising the integrity of the internal components. The ventilation system may be configured to prevent debris ingress while allowing moisture vapor to escape.

The housing 102 may incorporate sealing elements 112 between housing sections that may provide weather resistance and prevent moisture ingress into the internal mechanisms. The sealing elements 112 may comprise O-rings, gaskets, or molded sealing surfaces that may maintain environmental protection while allowing normal operational movement of external controls. The sealing system may be designed to accommodate thermal expansion and contraction while maintaining sealing effectiveness.

### B. a Reel Component

The leash apparatus 100 may include a reel component 114. The reel component 114 may be rotatably mounted within the housing through precision bearing assemblies that may support both radial and axial loads during operation. The reel 114 may comprise a cylindrical structure having a central hub 116 and peripheral flanges 118 that may contain the wound leash line during storage. The central hub 116 may be configured to receive a mounting shaft that may extend through the reel assembly and may be supported by bearings positioned at both ends of the shaft.

The reel 114 may be constructed from durable materials such as reinforced polycarbonate, aluminum alloy, or engineering plastics that may provide structural integrity under operational loads. The cylindrical surface 120 of the reel 114 may include textured areas or helical grooves that may promote even winding of the leash line during retraction operations. The peripheral flanges 118 may extend radially outward from the cylindrical surface 120 to prevent the leash line from unwinding beyond the intended storage area.

In some embodiments, the reel 114 may include gear teeth formed on its outer circumference to interface with a traditional brake mechanism. The gear teeth may be evenly spaced around the reel periphery to provide consistent engagement with the pawl mechanism during braking operations. The gear teeth may be molded integrally with the reel 114 or may comprise separate components that may be attached to the reel through mechanical fastening and/or adhesive bonding.

The central hub 116 may incorporate a keyed connection interface that may engage with the threaded drive shaft to ensure positive rotational coupling during leash extension and retraction operations. The keyed connection may comprise a hexagonal socket, splined interface, or pin connection that may prevent relative rotation between the reel 114 and drive shaft while accommodating assembly tolerances. The connection interface may be designed to withstand the torque loads generated during maximum extension conditions without slippage or wear.

The reel 114 may be balanced to minimize vibration and ensure smooth rotation during high-speed retraction operations. The weight distribution may be optimized through material selection and geometric design to position the center of mass coincident with the rotational axis. The balanced configuration may reduce bearing loads and extend the operational life of the mounting system.

The cylindrical surface 120 may include a lead-in chamfer or radius at the leash line attachment point to prevent sharp bends that may cause premature wear of the leash line material. The attachment point may comprise a reinforced area with increased wall thickness to distribute the concentrated loads applied by the leash line during extension operations. The attachment mechanism may comprise a mechanical clamp, adhesive bond, or molded-in connection that may provide reliable retention throughout the operational life of the apparatus 100.

### C. a Spring Component

In embodiments, the leash apparatus 100 may include a spring component. The spring component may comprise a spiral torsion spring 122 that may be operatively connected to the reel and may be configured to provide continuous retraction bias throughout the operational range of the leash apparatus. The spiral torsion spring 122 may be manufactured from high-carbon steel or stainless steel alloys that may provide fatigue resistance over extended operational cycles while maintaining consistent spring characteristics under varying environmental conditions.

The spiral torsion spring 122 may have a first end that may be anchored to a fixed mounting point within the housing through a mechanical attachment interface. The first end may be formed with a rectangular or square cross-section that may engage with a correspondingly shaped slot formed in the housing wall. The mechanical attachment interface may prevent relative rotation between the spring 122 and housing while providing secure anchoring under operational loads.

The spiral torsion spring 122 may have a second end that may be secured to the reel hub through a keyed connection or pin connection that may transmit rotational force during retraction operations. The second end may be formed with an eyelet configuration that may receive a mounting pin extending radially from the reel hub. The mounting pin may be press-fitted or threaded into the reel hub to provide a secure attachment point that may withstand the torque loads generated during spring operation.

The spring constant of the spiral torsion spring 122 may be selected to provide sufficient retraction force to overcome friction in the reel bearings and leash line guidance system while avoiding excessive force that may cause uncomfortable jerking of the attached animal. The spring rate may be calibrated to provide smooth retraction while maintaining adequate retraction speed for practical operation across the full extension range of the leash line.

The spiral torsion spring 122 may be enclosed within a protective housing cavity that may shield the spring from external contaminants while providing adequate space for spring deflection during operation. The housing cavity may include ventilation ports to prevent moisture accumulation while maintaining protection from debris ingress. The cavity walls may be smooth to prevent interference with spring movement during extension and retraction cycles.

The spiral torsion spring 122 may include a damping element that may control the retraction speed to prevent sudden jerking motions when the leash line is released. The damping element may comprise a viscous damper or friction damper that may be integrated with the spring assembly or may be positioned between the spring and reel connection points. The damping force may be calibrated to provide smooth retraction while maintaining adequate retraction speed for practical operation.

The spiral torsion spring 122 may be configured to maintain retraction force on the leash when the brake mechanism is engaged. The spring mechanism may continue to bias the reel toward the retracted position even when the brake prevents reel rotation, ensuring that retraction force may be immediately available when the brake is released. The spring preload may be adjusted during assembly to achieve the desired retraction force characteristics for the specific application requirements.

### D. a Leash Line Component

The leash line component 124 may comprise a flexible elongated member that may be wound around the reel and may extend from the housing during operation. The leash line 124 may be constructed from durable synthetic materials such as (but not limited to) nylon webbing, polyester tape, and/or braided polymer fibers that may provide adequate tensile strength for the intended animal control application. The leash line 124 may have a flat tape configuration with a width that may range from approximately 0.5 inches to 1.0 inches depending upon the size and strength characteristics of the animals to be controlled.

The first end of the leash line 124 may be securely attached to the reel through mechanical fastening methods that may prevent separation under operational loads. The attachment may comprise a loop configuration where the leash line 124 may be folded back upon itself and secured through stitching, heat welding, or mechanical clamping. The attachment point may be reinforced with additional material layers or backing plates to distribute attachment loads across a larger area of the leash line 124.

The second end of the leash line 124 may include an attachment mechanism that may provide connection to animal collars, harnesses, or other restraint devices. The attachment mechanism may comprise a spring-loaded snap hook, carabiner, or swivel connector that may allow secure attachment while providing rotational freedom to prevent leash line twisting. The attachment mechanism may be rated for load capacities that may exceed the expected operational forces by a safety factor of at least 3:1.

The leash line 124 may incorporate reflective elements or high-visibility coloring to enhance visibility during low-light conditions. The reflective elements may comprise retroreflective tape strips that may be bonded to the surface of the leash line 124 or reflective fibers that may be woven into the material structure. The reflective elements may be positioned to provide 360-degree visibility when the leash line 124 may be extended in any direction.

The surface of the leash line 124 may be treated with water-resistant coatings or may be manufactured from inherently water-repellent materials to maintain performance characteristics in wet conditions. The water resistance may prevent absorption of moisture that may increase the weight of the leash line 124 or may cause dimensional changes that may affect winding characteristics on the reel.

The leash line 124 may include length markings or graduations that may be printed, embossed, or otherwise applied to the surface at regular intervals. The markings may provide visual indication of the extended length to assist users in determining appropriate maximum length settings. The markings may be applied using fade-resistant inks or may be molded into the material structure to ensure long-term visibility.

The tensile strength of the leash line 124 may be selected based upon the maximum expected load that may be generated by the animal during normal use conditions. The leash line 124 may be tested to verify that the breaking strength may exceed the design load by an appropriate safety margin. The material selection may consider factors such as abrasion resistance, UV stability, and flexibility retention over the expected service life.

The leash line 124 may incorporate elastic properties through material selection or construction methods that may provide controlled stretch characteristics under load. The elastic properties may reduce shock loads that may be transmitted to both the animal and the user during sudden movements. The stretch characteristics may be calibrated to provide approximately 5% to 15% elongation at normal operational loads while maintaining adequate stiffness for control purposes.

### E. a Drive Screw Component

The drive screw component 126 may comprise a threaded shaft that may be mechanically coupled to the reel and may be configured to rotate in correspondence with reel rotation during leash extension and retraction operations. The drive screw 126 may be positioned parallel to the axis of reel rotation and may extend through a central portion of the housing assembly. The threaded exterior surface of the drive screw 126 may be configured with precision threading that may engage with the complementary threaded interior surface of the connector nut.

The drive screw 126 may be fabricated from durable materials such as stainless steel, hardened steel, or high-strength aluminum alloy that may provide adequate strength and wear resistance for extended operational cycles. The material selection may balance mechanical properties with weight considerations to maintain the overall portability of the apparatus. The drive screw 126 may be heat-treated or surface-hardened to enhance wear resistance at the threaded engagement surfaces.

The threading configuration of the drive screw 126 may comprise standard metric or unified thread forms with pitch dimensions selected to provide appropriate mechanical advantage during connector nut advancement. The thread pitch may be fine enough to provide precise positioning control while maintaining adequate strength for the operational loads. The threading may extend along the full operational length of the drive screw 126 to accommodate the complete range of connector nut travel.

The drive screw 126 may include a coupling mechanism at one end that may provide mechanical connection to the reel assembly. The coupling mechanism may comprise a keyed connection, splined interface, or threaded engagement that may ensure positive rotational correspondence between the reel and drive screw 126. The coupling may be designed to withstand the torque loads generated during maximum extension conditions without slippage or mechanical failure.

The drive screw 126 may be supported by thrust bearings positioned at one or both ends to accommodate the axial forces generated when the connector nut advances along the threaded shaft. The thrust bearing assemblies may be sized to handle the maximum axial force that may be generated during operation while maintaining smooth rotation of the drive screw 126. The bearing selection may comprise ball thrust bearings, roller thrust bearings, or sleeve bearings depending upon the specific load requirements.

The contact end of the drive screw 126 may be configured with a tapered or oblique surface that may provide smooth engagement with the limiter 128 when the connector nut reaches the predetermined maximum extension position. The tapered surface may reduce the contact area between the drive screw 126 and limiter 128, thereby minimizing friction and wear during contact operations. The taper angle may be machined to specific geometric tolerances that may promote smooth rotation and prevent binding of the mechanism.

The drive screw 126 may incorporate lubrication features such as grease fittings or oil passages that may distribute lubricating materials along the threaded surfaces. The lubrication system may reduce friction between the drive screw 126 and connector nut while extending the operational life of the threaded engagement. The lubrication features may be positioned to allow periodic maintenance without complete disassembly of the mechanism.

The drive screw 126 may include position indicators or reference marks that may provide visual feedback regarding the current extension status of the leash. The position indicators may comprise graduated markings, color-coded zones, or mechanical flags that may correspond to specific leash extension lengths. The indicators may be laser-etched or mechanically engraved to ensure durability throughout the operational life of the apparatus.

### F. a Limiter Component

The limiter component 128 may comprise a threaded screw element, a pin, plate, or any other component that may be configured to establish a mechanical stop for the drive shaft 126 during leash extension operations. The limiter 128 may be fabricated from durable materials such as hardened steel, stainless steel, or high-strength engineering plastics that may provide adequate strength and wear resistance for repeated contact operations. In some embodiments, the limiter 128 may have external threads that may engage with internal threads formed within the connector nut to allow precise positioning control through rotational adjustment.

The exterior surface of the limiter 128 may comprise standard metric or imperial thread forms with pitch dimensions selected to provide fine adjustment resolution while maintaining adequate mechanical advantage for manual operation. The thread pitch may range from approximately 0.5 millimeters to 2.0 millimeters depending upon the specific adjustment resolution requirements and operational torque considerations. The thread form may be designed to minimize friction during adjustment operations while providing secure positioning retention under operational loads.

The limiter 128 may have a length sufficient to accommodate the full range of adjustment needed for setting maximum leash extension limits from minimum to maximum operational distances. The overall length of the limiter 128 may be dimensioned to extend through the full thickness of the connector nut while providing adequate engagement length for secure threading. The length may typically range from approximately 25 millimeters to 75 millimeters depending upon the specific apparatus size and maximum adjustment range requirements.

The diameter of the limiter 128 may be selected to balance structural strength with compact packaging within the connector nut assembly. The major diameter of the threaded portion may range from approximately 6 millimeters to 12 millimeters depending upon the expected operational loads and space constraints within the housing assembly. The diameter selection may consider both the tensile strength requirements for contact loading and the thread engagement area needed for secure positioning.

The contact surface of the limiter 128 may be shaped to minimize wear and provide smooth engagement with the drive shaft 126 during contact operations. The contact surface may comprise a tapered or oblique profile that may reduce the contact surface area between the limiter 128 and drive shaft. The tapered end may be machined to a cone angle of approximately 30 to 60 degrees to promote smooth rotation and reduce or prevent binding during contact engagement.

The limiter 128 may be mounted within the connector nut through precision threading that may provide smooth adjustment operation while preventing backlash or play that may affect positioning accuracy. The threading engagement may include thread locking compounds or mechanical locking features that may prevent unintended adjustment during operational vibration or shock loading. The thread engagement length may be sufficient to distribute adjustment loads over multiple thread turns to prevent thread stripping or wear.

The limiter 128 may incorporate position indicating features such as graduated markings, detent positions, or electronic position sensors that may provide feedback regarding the current maximum length setting. The position indicators may be formed on the exterior surface of the limiter 128 or may comprise separate components that may interface with the limiter 128 during rotation. The position feedback may enable precise setting of maximum extension limits according to specific operational requirements.

The limiter 128 may include a clutch mechanism that may prevent over-torquing and potential damage to the threading during adjustment operations. The clutch mechanism may comprise a slip clutch or torque-limiting device that may allow rotation up to a predetermined torque level while preventing excessive force application. The clutch torque setting may be calibrated to allow normal adjustment operations while protecting the threading from damage due to excessive manual force.

### G. a Connector Component

The connector component may comprise a threaded connector nut 130 that may be configured to engage with both the drive shaft 126 and the limiter 128 through complementary threaded interfaces. The connector nut 130 may be fabricated from durable materials such as hardened steel, stainless steel, or high-strength engineering plastics that may provide adequate strength for operational loads while maintaining dimensional stability throughout the service life of the apparatus. The material selection may balance mechanical properties with weight considerations to maintain overall portability of the leash apparatus.

The connector nut 130 may comprise a non-circular cross-sectional profile that may correspond to a shaped channel formed within the housing to prevent rotational movement while allowing linear translation along the drive shaft axis. The non-circular configuration may comprise, as a non-limiting example, a hexagonal cross-section having six flat exterior surfaces, with at least one of those flat exterior surfaces interfacing with at least one corresponding flat interior surface of the hexagonal channel formed in the housing. The hexagonal geometry may provide uniform load distribution across multiple contact surfaces while maintaining precise rotational constraint.

The hexagonal cross-section of the connector nut 130 may be dimensioned with measurements that may provide a sliding fit within the housing channel while preventing rotational movement. The dimensional tolerances may be maintained to help ensure smooth linear translation without excessive clearance that may cause operational noise or positioning inaccuracy. The corner radii of the hexagonal profile may be specified to prevent stress concentrations while maintaining the rotational constraint function.

The connector nut 130 may include internal threading that may engage with the external threading of the drive shaft to provide the mechanical interface for linear advancement during drive shaft rotation. The internal threading may comprise standard metric or unified thread forms with pitch dimensions selected to provide appropriate mechanical advantage and positioning resolution. The thread engagement length may be sufficient to distribute operational loads over multiple thread turns to prevent thread stripping or premature wear.

The connector nut 130 may be configured with sufficient wall thickness to accommodate both sets of internal threading while maintaining structural integrity under operational loads. The wall thickness may be dimensioned to provide adequate thread engagement depth for both the drive shaft 126 and limiter 128 interfaces while maintaining compact overall dimensions. The material distribution may be optimized to provide maximum strength in the threaded engagement areas while minimizing overall weight.

The connector nut 130 may include lubrication features such as grease grooves or oil passages that may distribute lubricating materials to the threaded interfaces during operation. The lubrication features may comprise shallow channels formed in the thread roots or cross-drilled passages that may allow lubricant distribution throughout the threaded engagement areas. The lubrication system may reduce friction and extend the operational life of the threaded connections.

The connector nut 130 may incorporate wear-resistant surface treatments or coatings that may enhance durability and maintain smooth operation throughout the service life of the apparatus. The surface treatments may comprise hard anodizing for aluminum components, nitriding for steel parts, or specialized polymer coatings for enhanced lubricity. The coating selection may be based on the base material properties and expected operational environment.

The connector nut 130 may include retention features that may prevent complete disengagement from the drive shaft 126 and/or the limiter 128 during operation or maintenance activities. The retention features may comprise mechanical stops, snap rings, or thread relief areas that may allow normal operational movement while preventing inadvertent separation of the threaded connections. The retention system may be designed to allow intentional disassembly for maintenance while preventing accidental disconnection during use.

The connector nut 130 may be manufactured through precision machining operations that may ensure accurate thread forms and dimensional control for proper fit and function. The machining process may include thread milling or tapping operations performed on computer-controlled machine tools to maintain consistent thread geometry and surface finish. The manufacturing tolerances may be specified to ensure interchangeability of components across production quantities.

The connector nut 130 may incorporate position indicating features that may provide visual or tactile feedback regarding the current position along the drive shaft during operation. The position indicators may comprise graduated markings, color-coded zones, or mechanical flags that may correspond to specific leash extension lengths. The indicators may be laser-etched, mechanically engraved, or molded into the component surface to ensure durability throughout the operational life.

### H. a Ball Bearing

In some embodiments, the leash apparatus 100 may optionally include a ball bearing disposed between the drive screw 126 and the limiter 128. The ball bearing may comprise a spherical rolling element that may be positioned between the drive shaft 126 and limiter 128 to reduce friction during contact operations. The ball bearing may be fabricated from hardened steel, stainless steel, or ceramic materials that may provide durability and low friction characteristics under operational loads. The ball bearing may be precision-manufactured to maintain dimensional tolerances that may ensure smooth rolling motion and consistent contact geometry throughout the operational life of the apparatus.

The ball bearing may have a diameter that may be selected to provide appropriate contact geometry between the drive shaft 126 and limiter 128 while maintaining adequate load capacity for the expected operational forces. The diameter may typically range from approximately 3 millimeters to 8 millimeters depending upon the specific apparatus size and load requirements. The ball bearing may be sized to fit within the available space between the drive shaft end and limiter end while providing sufficient clearance for thermal expansion and manufacturing tolerances.

The ball bearing may be retained within a bearing seat that may be formed in either the drive shaft end or the limiter end to prevent displacement during operation. The bearing seat may comprise a hemispherical depression that may be machined or molded to match the ball bearing radius with appropriate clearance for smooth rotation. The seat depth may be dimensioned to provide secure retention while allowing the ball bearing to rotate freely under contact loads.

The ball bearing may be manufactured from Grade 25 chrome steel that may provide hardness ratings of approximately 60-67 HRC for enhanced wear resistance. The surface finish of the ball bearing may be maintained at approximately 4 microinches Ra or smoother to minimize friction and ensure smooth rolling contact. The spherical geometry may be maintained within tolerance specifications of ±0.0001 inches to ensure consistent contact characteristics and prevent binding during operation.

The ball bearing may incorporate a lubrication system that may distribute lubricating materials to the contact surfaces during operation. The lubrication may comprise synthetic grease or oil that may be compatible with the bearing materials and operational environment. The lubricant selection may consider factors such as temperature range, load capacity, and service life requirements for the specific application.

The ball bearing may be configured to accommodate both radial and axial loads that may be generated during contact between the drive shaft 126 and limiter 128. The load capacity may be calculated based upon the maximum force that may be transmitted through the leash line during operational use. The bearing selection may include appropriate safety factors to prevent premature failure under peak loading conditions.

The ball bearing may include a cage or separator that may maintain proper spacing and prevent contact between multiple bearings when multiple ball bearings are employed. The cage may be fabricated from polymer materials or metal alloys that may provide dimensional stability and chemical compatibility with the lubricating materials. The cage design may allow adequate lubricant flow while maintaining bearing alignment during operation.

The ball bearing may be sealed or shielded to prevent contamination from external debris while maintaining lubrication retention. The sealing system may comprise rubber seals or metal shields that may be integrated with the bearing assembly. The seal selection may balance contamination protection with friction considerations to maintain smooth operation throughout the service life.

The ball bearing may be preloaded to eliminate clearance and ensure consistent contact geometry during operation. The preload may be applied through the limiter positioning or through spring-loaded retention mechanisms. The preload magnitude may be calibrated to provide smooth operation while preventing excessive friction that may interfere with the adjustment mechanism function.

The ball bearing may be replaceable to allow maintenance and service life extension of the apparatus. The replacement procedure may be accomplished through disassembly of the connector nut or through access ports provided in the housing assembly.

### I. a Gearing Mechanism

In some embodiments, the apparatus 100 may include a gearing mechanism 134, as shown in FIG. 6. Referring to FIG. 6, the gearing mechanism 134 may comprise a comprehensive gear train system that may provide enhanced operational control over the maximum length adjustment functionality. The gearing mechanism 134 may include a drive gear 136 that may be mechanically coupled to the drive shaft 126 such that rotation of the drive shaft may cause corresponding rotation of the drive gear 136. The drive gear 136 may be fabricated from hardened steel or engineering plastics and may be sized to provide appropriate torque transmission characteristics for the operational loads expected during leash extension operations.

The gearing mechanism 134 may include a primary gear 138 that may be positioned to mesh with the drive gear 136 and may serve as an intermediate element in the gear train. The primary gear 138 may have a diameter and tooth count selected to provide the desired gear ratio between the drive gear 136 and subsequent elements in the gear train. The primary gear 138 may be rotatably mounted on a shaft that may be supported by bearings within the housing to ensure smooth operation throughout the operational range.

The gearing mechanism 134 may include a reverse gear 140 that may be positioned to mesh with the primary gear 138 and may provide directional reversal of the rotational motion transmitted through the gear train. The reverse gear 140 may be sized and configured to maintain the appropriate gear ratio while reversing the direction of rotation from the primary gear 138. The reverse gear 140 may be manufactured from materials compatible with the other gears in the system and may be mounted on precision bearings to minimize friction during operation.

The gearing mechanism 134 may include an adjustment gear 142 that may be mechanically coupled to the limiter 128 such that rotation of the adjustment gear 142 may cause corresponding rotation of the limiter within the connector nut. The adjustment gear 142 may mesh with the reverse gear 140 to complete the gear train connection from the drive gear 136 to the limiter. The adjustment gear 142 may be sized to provide the final gear ratio that may determine the relationship between drive shaft rotation and limiter rotation.

The gear train configuration may be designed such that rotation of the drive shaft 126 may cause the drive gear 136 to rotate, which may in turn cause rotation of the primary gear 138 in the opposite direction. The primary gear 138 may cause rotation of the reverse gear 140, which may then cause rotation of the adjustment gear 142 in the same direction as the original drive gear 136 rotation. This gear train arrangement may result in the limiter 128 rotating in the opposite direction to the drive shaft 126, thereby maintaining a constant relative position between the drive shaft and limiter when the gearing mechanism 134 is engaged.

The gearing mechanism 134 may include a rocker arm that may be pivotably mounted within the housing 102 and may be configured to selectively engage and disengage at least one gear of the gear train. The rocker arm may be positioned to interface with one or more of the primary gear 138 or reverse gear 140 to provide selective engagement of the gear train. When the rocker arm is in the engaged position, the gear train may operate as described above to maintain the relative position between the drive shaft and limiter.

The rocker arm may be actuated through an external switch that may be accessible from the exterior of the housing 102 and may allow the user to selectively engage and disengage the gearing mechanism 134. The external switch may comprise a lever, button, or sliding control that may be mechanically linked to the rocker arm through a suitable linkage mechanism. When the external switch is actuated to the disengaged position, the rocker arm may move one or more gears (e.g., the primary gear 138 and/or the reverse gear 140) out of mesh, thereby breaking the gear train connection and allowing the limiter 128 to remain in a fixed position while the drive shaft 126 continues to rotate during leash extension.

The selective engagement capability of the gearing mechanism 134 may provide operational flexibility by allowing the user to choose between two distinct operating modes. In the engaged mode, the leash may extend freely to its full length because the limiter 128 may rotate to maintain its relative position with respect to the drive shaft 126. In the disengaged mode, the limiter 128 may remain stationary, creating a mechanical stop that may limit leash extension to whatever length corresponds to the current position of the limiter when the gearing mechanism 134 was disengaged.

The rocker arm may be spring-loaded to maintain its position in either the engaged or disengaged state until deliberately actuated by the user through the external switch. The spring loading may provide tactile feedback to confirm the engagement state and may prevent inadvertent changes during normal handling of the apparatus. The rocker arm may include detent positions or other position indicating features that may provide visual or tactile confirmation of the current engagement state.

The gear teeth on all gears within the gearing mechanism 134 may be manufactured to precise tolerances to ensure smooth meshing and minimize backlash that could affect positioning accuracy. The tooth profiles may comprise involute geometry or other suitable forms that may provide smooth power transmission and minimize noise during operation. The gear materials may be selected for compatibility with the expected operational environment and may include appropriate surface treatments or coatings to enhance durability and reduce friction.

### J. a Traditional Locking Mechanism Component

In some embodiments, the leash apparatus 100 may include a traditional locking component. The traditional locking component may comprise a pawl-based engagement system that may be configured to selectively prevent rotation of the reel in both extension and retraction directions. The traditional locking component may provide immediate stopping capability that may operate independently of the threaded drive shaft system and maximum length adjustment mechanism. The traditional locking component may allow users to lock the leash at any desired length within the operational range regardless of the current position of the connector nut or limiter.

The pawl element may comprise a spring-loaded engagement member that may be fabricated from hardened steel or other wear-resistant materials to withstand repeated engagement and disengagement cycles during operational use. The pawl may include a curved engagement surface that may conform to the tooth profile of gear teeth formed on the periphery of the reel. The curved engagement surface may maximize contact area and may distribute engagement forces across multiple contact points to prevent localized wear or damage to either the pawl or reel teeth.

The gear teeth may be formed on the outer circumference of the reel with a sawtooth profile that may allow the pawl to engage in one rotational direction while providing a cam action that may facilitate disengagement when rotation is attempted in the opposite direction. The gear teeth may be evenly spaced around the reel periphery to provide consistent engagement characteristics regardless of the reel rotational position when the brake mechanism is activated. The tooth spacing may be selected to provide multiple engagement points around the reel circumference while maintaining adequate tooth strength for the expected operational loads.

The pawl mounting arrangement may comprise a pivot pin that may be secured within the housing through press-fit installation or threaded engagement. The pivot pin may be positioned to allow the pawl to rotate through an arc that may bring the engagement surface into contact with the reel teeth when the actuator is depressed. The pivot pin may be manufactured from stainless steel or other corrosion-resistant materials to ensure smooth pivoting action throughout the operational life of the apparatus.

A torsion spring may be positioned around the pivot pin to provide the biasing force that may maintain the pawl in engagement with the reel teeth when the actuator is activated. The torsion spring may be calibrated to provide sufficient engagement force to prevent reel rotation under normal operational loads while allowing manual disengagement through the actuator mechanism. The spring rate may be selected to balance reliable engagement with ease of release operation for comfortable user interaction.

The actuator may comprise a button that may be accessible from the exterior surface of the housing and may be positioned for convenient thumb operation while gripping the housing. The button may be connected to the pawl through a mechanical linkage that may translate the linear motion of button depression into rotational motion of the pawl about the pivot pin. The mechanical linkage may comprise a cam mechanism or lever arrangement that may provide mechanical advantage to overcome the spring bias during pawl disengagement.

When the button is depressed, the mechanical linkage may cause the pawl to rotate away from the reel teeth, thereby disengaging the brake mechanism and allowing free rotation of the reel in both directions. The button may be spring-loaded to return to the extended position when released, which may allow the torsion spring to rotate the pawl back into engagement with the reel teeth. The button spring may be calibrated to provide tactile feedback to the user while maintaining reliable return operation.

The traditional locking component may be configured to override the maximum extension limit set by the limiter when engaged. The brake mechanism may provide immediate stopping capability that may function regardless of the current position of the drive shaft or connector nut within the threaded mechanism. The override capability may allow users to lock the leash at any length within the operational range, including lengths that may be shorter than the maximum extension limit established by the limiter position.

The engagement mechanism may be configured to maintain positive engagement between the pawl and reel teeth when the button is held in the depressed position. The pawl engagement surface may include multiple contact points that may distribute the braking forces across several reel teeth to prevent localized wear or damage. The tooth geometry may be designed with appropriate lead angles to facilitate smooth engagement while preventing inadvertent disengagement under load conditions.

In use, the operator may selectively engage a brake mechanism to prevent rotation of the reel in both extension and retraction directions. When engaged, the brake locks the leash at any desired length, independent of the predetermined extension limit established by the limiter. This allows the user to override the set maximum extension at any time, providing immediate restraint control by restricting both further extension and retraction of the leash until the brake is released.

The traditional locking component may include a release mechanism that may allow for quick transitions between locked and unlocked states during operation. The release mechanism may comprise the same button actuator used for engagement, providing a single-control interface for both locking and unlocking functions. The release operation may be accomplished by releasing the button, which may allow the spring-loaded pawl to disengage from the reel teeth and permit normal reel rotation.

The pawl may include a wear-resistant coating or surface treatment to extend operational life and maintain consistent engagement characteristics throughout the service life of the apparatus. The coating may comprise hard chrome plating, nitriding, or ceramic coating depending upon the base material and operational requirements. The surface treatment may be selected to provide low friction during engagement and disengagement while maintaining high wear resistance during braking operations.

### III. Platform Operation

The method may be embodied as a sequence of operations that may be performed by the retractable leash apparatus components working in coordination. Different operations may be performed by different elements of the apparatus in operative communication with one another. The housing component may perform certain stages while the reel component, drive shaft component, or limiter component may perform other stages simultaneously or sequentially.

The stages of the method may be initiated by user input or may occur automatically in response to mechanical forces applied to the leash line. The method may be performed repeatedly throughout the operational life of the apparatus as the leash extends and retracts during normal use. The sequence of stages may vary depending upon the current configuration of the adjustment mechanism and the operational state of any optional components such as the gearing system or traditional brake mechanism.

Accordingly, the various stages of the method may be performed by one or more actors in different sequences and arrangements without departing from the scope of the present disclosure. The method stages may be combined, separated, reordered, or performed concurrently by different components of the apparatus. Various intermediary stages may exist between the disclosed stages, and additional stages may be added or removed without altering the fundamental scope of the method.

The method may accommodate variations in the order of operations while maintaining the functional relationship between the mechanical components. The adjustment of the threaded limiter position may occur before, during, or after leash extension operations without affecting the fundamental operation of the maximum length limiting function. The rotational correspondence between the reel and drive shaft may be maintained regardless of the sequence in which other method stages are performed.

The method may be performed with different timing relationships between the various stages depending upon the specific mechanical configuration and user preferences. The advancement of the connector nut along the drive shaft may occur continuously during leash extension or may occur in discrete increments depending upon the thread pitch and rotational characteristics of the drive shaft. The contact between the drive shaft and limiter may occur gradually or abruptly depending upon the contact surface geometry and mechanical tolerances of the components.

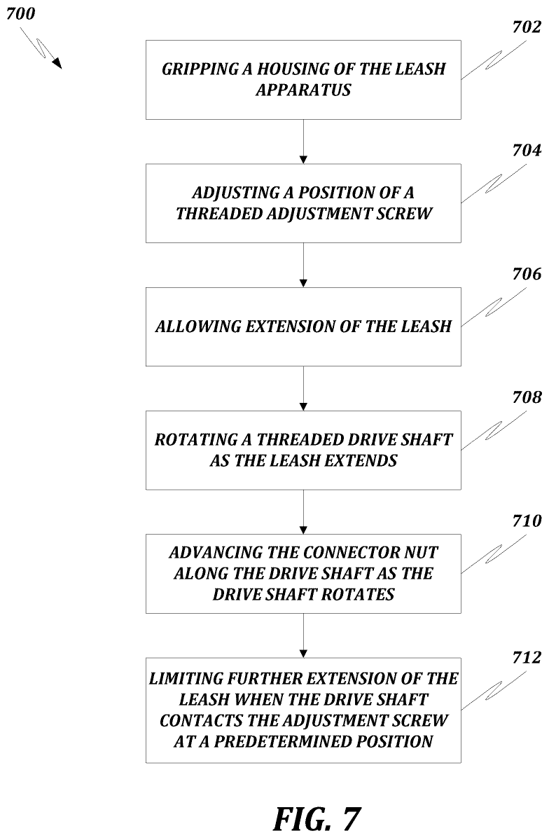

Referring to FIG. 7, the method illustrated may comprise a sequence of operational stages that may be performed during use of the retractable leash apparatus 100. The method may begin at stage 702 where a user may grip the housing 102 of the leash apparatus to prepare for operation. The gripping operation may involve positioning the housing within the user's hand such that the manual controls may be accessible while maintaining secure control of the apparatus during pet management activities.

The method may proceed to stage 704 where the user may adjust the position of the threaded limiter 128 to establish the desired maximum extension length for the particular usage scenario. The adjustment operation may be performed through manipulation of the manual control dial 108 that may be accessible from the exterior surface of the housing 102. Rotation of the control dial 108 may cause corresponding rotation of the limiter 128, which may advance or retract the limiter within the connector nut 130 to establish the predetermined maximum extension limit.

In one example embodiment of stage 704, the user may rotate the control dial 108 clockwise to advance the limiter 128 deeper into the connector nut 130, thereby reducing the distance between the drive shaft 126 and the limiter 128 when the connector nut reaches its maximum travel position. This configuration may result in a shorter maximum extension length for the leash line 124. Alternatively, the user may rotate the control dial 108 counterclockwise to retract the limiter 128 within the connector nut 130, thereby increasing the distance between the drive shaft 126 and limiter 128 and allowing for a longer maximum extension length.

The method may continue to stage 706 where the user may allow extension of the leash 124 by permitting the attached animal to move away from the user's position. The extension operation may occur naturally as the animal applies tension to the leash line 124, causing the reel 114 to rotate against the bias of the spring mechanism 122. The spring mechanism 122 may maintain continuous retraction force on the leash line 124 throughout the extension process while allowing controlled unwinding of the leash from the reel 114.

In an example embodiment of stage 706, the user may release any traditional brake mechanism that may be engaged and may allow the attached dog to walk forward, creating tension in the leash line 124. The tension force may overcome the retraction bias of the spring mechanism 122, causing the reel 114 to rotate in the extension direction. The leash line 124 may unwind smoothly from the reel 114 and may extend through the leash exit opening 106 as the animal moves to the desired distance.

Stage 708 may involve the rotation of the threaded drive shaft 126 in correspondence with the reel rotation during leash extension operations. The drive shaft 126 may be mechanically coupled to the reel 114 through a keyed connection or other positive engagement mechanism that may ensure rotational correspondence between these components. As the reel 114 rotates during leash extension, the drive shaft 126 may rotate at the same angular velocity and in the same rotational direction.

In one example embodiment of stage 708, the drive shaft 126 may be directly connected to the central hub of the reel 114 through a hexagonal socket engagement. As the leash line 124 extends and causes the reel 114 to rotate clockwise when viewed from the drive shaft end, the drive shaft 126 may simultaneously rotate clockwise at the same rate. The threaded exterior surface of the drive shaft 126 may engage with the internal threads of the connector nut 130 during this rotation process.

The method may proceed to stage 710 where the connector nut 130 may advance along the drive shaft 126 as the drive shaft rotates. The connector nut 130 may be constrained from rotation within the housing 102 through the hexagonal channel configuration that may prevent rotational movement while allowing linear translation along the drive shaft axis. As the drive shaft 126 rotates, the threaded engagement between the drive shaft 126 and connector nut 130 may cause the connector nut to translate linearly along the shaft.

In an example embodiment of stage 710, the hexagonal connector nut 130 may be positioned within the corresponding hexagonal channel formed in the housing 102. As the drive shaft 126 rotates during leash extension, the threaded interface between the drive shaft 126 and the internal threads of the connector nut 130 may cause the connector nut to advance along the drive shaft axis. The hexagonal exterior of the connector nut 130 may slide within the hexagonal channel while being prevented from rotating, thereby converting the rotational motion of the drive shaft 126 into linear motion of the connector nut 130.

The method may conclude at stage 712 where further extension of the leash 124 may be limited when the drive shaft 126 contacts the limiter 128 at the predetermined position established during stage 704. The contact between the drive shaft 126 and limiter 128 may create a mechanical stop that may prevent additional rotation of the drive shaft 126 and reel 114 in the extension direction while maintaining the capability for retraction through reverse rotation.

In one example embodiment of stage 712, the connector nut 130 may advance along the drive shaft 126 until the end of the drive shaft 126 contacts the end of the limiter 128 within the connector nut. The contact may occur when the connector nut 130 reaches the position where the distance between the drive shaft end and limiter end equals zero. At this point, the mechanical interference between these components may prevent further rotation of the drive shaft 126 in the extension direction, thereby limiting additional leash extension. The spring mechanism 122 may continue to maintain retraction bias, allowing the leash 124 to retract immediately when the extension force is reduced, causing the drive shaft 126 to rotate in the opposite direction and the connector nut 130 to translate back along the drive shaft axis.

Retracting the leash may occur automatically when the extension force is relaxed. In this mode of operation, the drive shaft rotates in a direction opposite to that experienced during extension, resulting in the connector nut translating back along the drive shaft away from the limiter. This motion, enabled by the configuration of the threaded engagements, restores the apparatus to its ready state for subsequent extensions and limit adjustments. The mechanism is designed such that the transition between extension and automatic retraction is seamless and requires no user intervention beyond the reduction of leash tension.

In an illustrative use scenario, a user preparing to walk their dog may first rotate the manual control dial on the housing to set the desired maximum leash extension. As the dog begins to walk away, the leash line automatically unwinds from the reel, and the reel and drive shaft rotate in unison. As the leash extends, the connector nut travels along the drive shaft toward the limiter. When the leash reaches the set maximum extension, the end of the drive shaft contacts the limiter, creating a positive mechanical stop that prevents further leash extension. If the user wishes to allow more or less freedom, the user can adjust the control dial to reposition the limiter and modify the extension limit as desired, even during use. If rapid restraint is needed, such as in a crowded area, the user may engage the traditional brake mechanism to immediately lock the leash at its current length. At all times, the spring mechanism maintains tension on the leash, ensuring smooth retraction as the dog moves closer.

In some embodiments, the maximum extension setting may be visually indicated through a position indicator window on the housing, allowing the user to confirm the current configuration at a glance. The manual control dial may offer incremental adjustment, enabling fine-tuned control suitable for various environments, such as crowded sidewalks or open parks. During operation, the user may switch between allowing maximum leash extension and temporarily limiting the extension by rotating the control dial without interrupting the primary walking activity. If a sudden change in the walking environment occurs, such as unexpected pedestrian traffic, the user may rapidly reduce the maximum extension by simply rotating the manual control dial, causing the limiter to advance toward the drive shaft and decrease the permissible leash length.

The apparatus may also accommodate scenarios in which the operator releases the brake and allows the dog to move closer, with the spring mechanism smoothly retracting the leash line onto the reel without slack or tangling. The construction of the connector nut and limiter, supported by low-friction surfaces and bearings, may ensure reliable operation with minimal resistance. If adjustment is performed while the leash is under tension, the gearing system, if present, may permit the limiter to be repositioned relative to the drive shaft, allowing real-time adaptation of leash extension without adverse effects on the retraction mechanism. In multi-dog walking situations, the capability to instantly set different maximum extensions may facilitate control and safety for each animal, as the operator can adjust the restraint for individual needs during the same outing.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A retractable leash apparatus comprising:
a housing;
a reel rotatably mounted within the housing;
a leash wound around the reel and extendable from the housing;
a threaded drive shaft coupled to the reel and configured to rotate with the reel;
a threaded connector nut engaged with the drive shaft and constrained from rotation within the housing;
a limiter configured to engage with the connector nut and positioned to contact the drive shaft; and
a manual control accessible from an exterior of the housing and coupled to the limiter to allow user adjustment of a position of the limiter,
wherein rotation of the reel causes the drive shaft to rotate and advance the connector nut along the drive shaft until the drive shaft contacts the limiter to limit extension of the leash.

2. The retractable leash apparatus of claim 1, wherein the connector nut comprises a non-circular cross-section and the housing comprises a corresponding channel configured to receive the connector nut and prevent rotation of the connector nut while allowing linear translation.

3. The retractable leash apparatus of claim 1, further comprising a spring mechanism operatively connected to the reel and configured to bias the reel toward a retracted position to maintain tension on the leash.

4. The retractable leash apparatus of claim 1, wherein the manual control comprises a rotatable dial positioned on an exterior surface of the housing and mechanically coupled to the limiter.

5. The retractable leash apparatus of claim 1, further comprising a friction-reducing element disposed between the drive shaft and the limiter to minimize wear during contact.

6. The retractable leash apparatus of claim 1, wherein the drive shaft and the limiter comprise tapered contact surfaces configured to provide smooth engagement and minimize binding.

7. The retractable leash apparatus of claim 1, further comprising a gearing mechanism comprising:
a drive gear coupled to the drive shaft;
an adjustment gear coupled to the limiter; and
at least one intermediate gear meshed between the drive gear and the adjustment gear, wherein the at least one intermediate gear is configured to selectively engage the adjustment gear, and wherein the gearing system is configured to maintain a fixed relative position between the drive shaft and the limiter when the at least one intermediate gear is engaged.

8. The retractable leash apparatus of claim 7, wherein when the gearing mechanism is engaged, the gearing mechanism is configured to cause rotation of the adjustment gear in an opposite direction relative to the drive gear, causing the limiter to maintain at a fixed relative distance from the drive shaft when engaged.

9. The retractable leash apparatus of claim 8, wherein when the gearing mechanism is disengaged, the limiter remains in a fixed position relative to the housing while the drive shaft rotates during leash extension.

10. A retractable leash apparatus comprising:
a housing;
a reel rotatably mounted within the housing;
a leash wound around the reel and extendable from the housing;
a threaded drive shaft coupled to the reel and configured to rotate with the reel;
a threaded connector nut engaged with the drive shaft and constrained from rotation within the housing;
a limiter engaged with the connector nut and positioned to contact the drive shaft; and
a manual control accessible from an exterior of the housing and coupled to the limiter to allow user adjustment of a position of the limiter,
wherein rotation of the reel causes the drive shaft to rotate and advance the connector nut along the drive shaft until the drive shaft contacts the limiter to limit extension of the leash.

11. The retractable leash apparatus of claim 10, wherein the connector nut comprises a non-circular cross-section and the housing comprises a corresponding channel configured to receive the connector nut and prevent rotation of the connector nut while allowing linear translation.

12. The retractable leash apparatus of claim 10, further comprising a spring mechanism operatively connected to the reel and configured to bias the reel toward a retracted position to maintain tension on the leash.

13. The retractable leash apparatus of claim 10, wherein the manual control comprises a rotatable dial positioned on an exterior surface of the housing and mechanically coupled to the limiter.

14. The retractable leash apparatus of claim 10, further comprising a friction-reducing element disposed between the drive shaft and the limiter to minimize wear during contact.

15. The retractable leash apparatus of claim 10, wherein the drive shaft and the limiter comprise tapered contact surfaces configured to provide smooth engagement and minimize binding.

16. The retractable leash apparatus of claim 10, further comprising a gearing mechanism comprising:
a drive gear coupled to the drive shaft;
an adjustment gear coupled to the limiter; and
a pair of intermediate gears meshed between the drive gear and the adjustment gear, wherein at least one intermediate gear is configured to selectively engage the adjustment gear, and wherein the gearing system is configured to maintain a fixed relative position between the drive shaft and the limiter when the at least one intermediate gear is engaged.

17. The retractable leash apparatus of claim 16, wherein when the gearing mechanism is engaged, the gearing mechanism is configured to cause rotation of the adjustment gear in an opposite direction relative to the drive gear, causing the limiter to maintain at a fixed relative distance from the drive shaft when engaged.

18. The retractable leash apparatus of claim 16, wherein when the gearing mechanism is disengaged, the limiter remains in a fixed position relative to the housing while the drive shaft rotates during leash extension.

19. A retractable leash apparatus comprising:
a housing;
a reel rotatably mounted within the housing;
a leash wound around the reel and extendable from the housing;
a threaded drive shaft coupled to the reel and configured to rotate with the reel;
a threaded connector nut engaged with the drive shaft and constrained from rotation within the housing;
a limiter engaged with the connector nut and positioned to contact the drive shaft;
a manual control accessible from an exterior of the housing and coupled to the adjustment screw to allow user adjustment of a position of the adjustment screw; and
a gearing mechanism comprising:
a drive gear coupled to the drive shaft;
an adjustment gear coupled to the adjustment screw; and
at least one intermediate gear meshed between the drive gear and the adjustment gear,
wherein the at least one intermediate gear is configured to selectively engage the adjustment gear, and wherein the gearing mechanism is configured to maintain a fixed relative position between the drive shaft and the adjustment screw when the at least one intermediate gear is engaged,
wherein rotation of the reel causes the drive shaft to rotate and advance the connector nut along the drive shaft until the drive shaft contacts the adjustment screw to limit extension of the leash.

20. The retractable leash apparatus of claim 19, wherein:
when the gearing mechanism is engaged, the gearing mechanism is configured to cause rotation of the adjustment gear in an opposite direction relative to the drive gear, causing the adjustment screw to maintain a fixed relative distance from the drive shaft when engaged, and
when the gearing mechanism is disengaged, the adjustment screw remains in a fixed position relative to the housing while the drive shaft rotates during leash extension.
